(19) United States
(12) Patent Application Publication
(10) Pub. No.: US 2009/0287331 A1
(43) Pub. Date: Nov. 19, 2009

(54) Systems and Methods for Bio-Refinery Application Management and Process Improvement

(75) Inventors: Rabindra Chakraborty, Johns Creek, GA (US); Shoma Chakraborty, Johns Creek, GA (US)

Correspondence Address: Jones IP Law, LLC, P.O.Box 672646, Marietta, GA, 30006, US

(73) Assignee: SHOMA INC., Johns Creek, GA (US)

(21) Appl. No.: 12/509,629

(22) Filed: Jul. 27, 2009

(51) Int. Cl. G05B 19/418

(52) U.S. Cl. 700/96

(57) ABSTRACT

Systems and methods are provided for management of bio-fuel production research and development, comprising (1) mapping process template layers into process segments, wherein each process template layer specifies configuration of a bio-fuel manufacturing process via process segments, and wherein each process segment specifies a stage of the bio-fuel manufacturing process via a grouping of segment modules, (2) recording specified data at each segment module, wherein the specified data includes input data, output data, and environment data, (3) configuring workflow through each process segment according to the segment modules within respective process segments, and wherein the workflow specifies the segment modules that are present and the order of the segment modules, and (4) providing the specified data to a research and development lifecycle management module for determination of results based on tracking and comparison of specified data, and wherein segment modules are modified based on the determined results.

### TECHNICAL FIELD

The present invention relates generally to bio fuels, and more particularly to management of bio-fuel production research and development.

### BACKGROUND

Ethanol manufacturing is not new. Indeed, the wine industry has been using ethanol manufacturing technology for a long time, and some technologies for converting raw ingredients into ethanol date as far back as the 1930s. For example, sugarcane and sugar beets are used as conventional sugar feedstock. Brazil produces ethanol from sugarcane and uses it for the transportation purposes. Other well known feedstock include cereal grains such as corn, wheat, barley and sorghum. In the United States, corn is used as the prime feedstock for ethanol production.

However, recent developments are placing an emphasis on moving away from edible feedstock to use non-food materials such as grass, wood, agricultural residue, forest residue and other lignocellulosic feedstocks, as the input biomass.

Cellulosic biomass is the most abundant biological material on the planet and has the potential to revolutionize the fuel ethanol industry. However, the complexity of the cellulosic biomass requires more extensive processing than corn grain, for example. Thus, there exists a need for management of the research and development necessary for converting non-edible biomass into ethanol.

### SUMMARY

Briefly described, and according to one embodiment, the present invention is directed towards systems and methods for management of bio-fuel production research and development.

Among green technology alternatives, a configurable computer application system, such as a bio refinery application, can manage the research and development (R&D) lifecycle and map pilot level manufacturing methods into production scale technologies. Such a system can also generate a set of metrics for comparison of these processes, and contribute to the emergence of an industry standard.

Presently, at least 6 different bio-fuel manufacturing methods are being explored. These “ballpark practical” measures, such as conversion process efficiency, throughput, and average cost of unit production of bio-fuel can be extremely helpful in determining progress along the technology evolution. Also, to improve the overall efficiency and cost effectiveness, it is desirable that a system have capability to correlate these “practical set of output measures” with the input parameters, characteristics and environmental parameters, to quantify the output improvement when one feedstock is used over another, when one production method is used over another or when a particular choice of chemical or bio reagents is made with their specific property, over another.

The present invention provides for (1) managing the R&D lifecycle while also protecting the confidentiality of information, (2) managing production methods and (3) benchmarking across processes through accurate comparison.

The management of the R&D lifecycle captures information related to the R&D lifecycle and effort. Capturing the lifecycle information provides for transforming from a concept to a pilot program, from the pilot program to a demonstration, and then from demonstration to a production technology. Additionally, lifecycle management can contribute to transitioning an R&D observation by improving a manufacturing method that is already in production, simply by inserting additional process steps.

Management of production methods provides for automation of data collection at each segment and also at various stages of the production steps. These data are received, for example, from other systems, environmental sensors or other input devices. Additionally, as a process becomes more mature or fine tuned over time, improvements related to cost and efficiency are tracked for each combination of input biomass, reagents and process steps within a particular manufacturing process.

Accurate comparison contributes to benchmarking across processes. Comparison of unit costs of production and efficiency for various competitive manufacturing methods contributes to setting an industry trend for the most suited and adoptable technology for a given context. It should also be noted that each bio-manufacturing process has its own particular advantages; however the “bio” part of the process depends on factors as varied as the climate, geography, and diversity and availability of certain types of vegetation or microorganisms, among others. The present inventions contribute to determination of an approach that is best suited for a particular geography and weather pattern.

In one embodiment, a computer-implemented method for management of bio-fuel production research and development, comprises (1) mapping at least one process template layer into a plurality of process segments, wherein each process template layer specifies configuration of a bio-fuel manufacturing process via the plurality of process segments, and wherein each process segment specifies a stage of the bio-fuel manufacturing process via a grouping of segment modules, (2) recording specified data at each segment module, wherein the specified data includes input data, output data, and environment data, (3) configuring workflow through each process segment according to the segment modules within the respective process segment, and wherein the workflow specifies the segment modules that are present and the order of the segment modules and (4) providing the specified data to a research and development lifecycle management module for determination of results based on tracking and comparison of specified data, and wherein segment modules are modified based on the determined results.

In another embodiment, segment modules are added to a process segment based on the determined results.

In another embodiment, each segment module includes process steps to define the workflow between respective segment modules.

In another embodiment, the process template layer is a cellulosic ethanol biological template.

In another embodiment, the process template layer is a cellulosic ethanol gasification template.

In another embodiment, the process template layer is an algal biodiesel template.

In another embodiment, the process template layer is a green gasoline template.

In another embodiment, the process template layer is a biobutanol template.

In another embodiment, the process template layer is a designer hydrocarbons template.

In another embodiment, the process template layer is a fourth generation fuel template.

In another embodiment, a process segment specifies pre-treatment of biomass to separate cellulose from other biomass materials.

In another embodiment, a process segment specifies conversion of cellulose into simple sugars.

In another embodiment, a process segment specifies extraction of ethanol from water and other components of the simple sugars.

In another embodiment, a process segment specifies re-utilization of by-products to produce electricity for ethanol production and to purify used reagents from the conversion.

In another embodiment, the cellulosic ethanol biological template includes the following segment modules: biomass handling module, biomass pretreatment module, hydrolysis module, fermentation module, fuel recovery module and lignin utilization.

In another embodiment, the specified data further includes at least one of chemical reagent data and bio-reagent data.

In another embodiment, recording the specified data further comprises recording process functionality information.

In another embodiment, the environment data further includes interface data.

In another embodiment, the interface data further includes sensor data.

In another embodiment, the workflow further comprises transferring information from one segment module to another segment module based on triggering of events.

In another embodiment, the recording further includes an application programming and sensor interface (APSI) that specifies the format of data transfer, the type of data, the frequency of data capture and the source of data.

In another embodiment, the recording further comprises receiving an automatic upload of an image data type.

Another embodiment further comprises maintaining confidentiality of the specified data.

In another embodiment, a system is provided for management of bio-fuel production research and development, the system comprising (1) a plurality of computer-implemented process template layer modules, wherein each process template layer module specifies configuration of a bio-fuel manufacturing process and further comprising (1.i) a plurality of process segments, each corresponding to a particular stage of the bio-fuel manufacturing process, (1.ii) a research and development production management module configured to record specified data at each process segment, wherein the specified data includes input data, output data, and environment data and (1.iii) a research and development lifecycle management module configured for determination of results based on tracking and comparison of the specified data and to modify process segments to achieve desired results in the bio-fuel manufacturing process and (2) an application programming and sensor interface (APSI) for importing and extracting data, the APSI comprising (2.i) an import gateway configured to import the specified data to each process segment, and wherein the specified data is imported from at least one of external systems and external sensors and (2.ii) an extractor configured to map data from each process segment to an external data system.

In another embodiment, the APSI further comprises an XML gateway, at least one standard sensor interface, at least one standard image interface and a mapping editor.

In another embodiment, a mapping editor is configured for user selection of a form having the following fields that specify a data storage location: static data, environmental data and configurable data.

In another embodiment, the mapping editor is further configured for user specification of a new data storage location in the absence of a configurable data field in the form.

Other systems, methods, features and advantages of the present invention will be or become apparent to one with skill in the art upon examination of the following drawings and detailed description. It is intended that all such additional systems, methods, features and advantages be included within this description and be within the scope of the present disclosure.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a high level overview of exemplary aspects of a system for management of bio-fuel production research and development.

FIG. 2 is a diagram illustrating an exemplary process for the manufacture of cellulosic ethanol from biomass using a biological conversion template.

FIG. 3 is an exemplary entity relationship diagram for a database illustrating the relationship of a process template as linked to a process, and with the process linked to process steps.

FIG. 4 is an exemplary form for prescribing the elements in a bio application form for mapping data into the process segments, as well as to the database from the process segments.

### DETAILED DESCRIPTION

Reference is now made in detail to the description of the embodiments of systems and methods for management of bio-fuel production research and development as illustrated in the accompanying drawings. The invention may, however, be embodied in many different forms and should not be construed as limited to the embodiments set forth herein; rather, these embodiments are intended to convey the scope of the invention to those skilled in the art. Furthermore, all “examples” given herein are intended to be non-limiting.

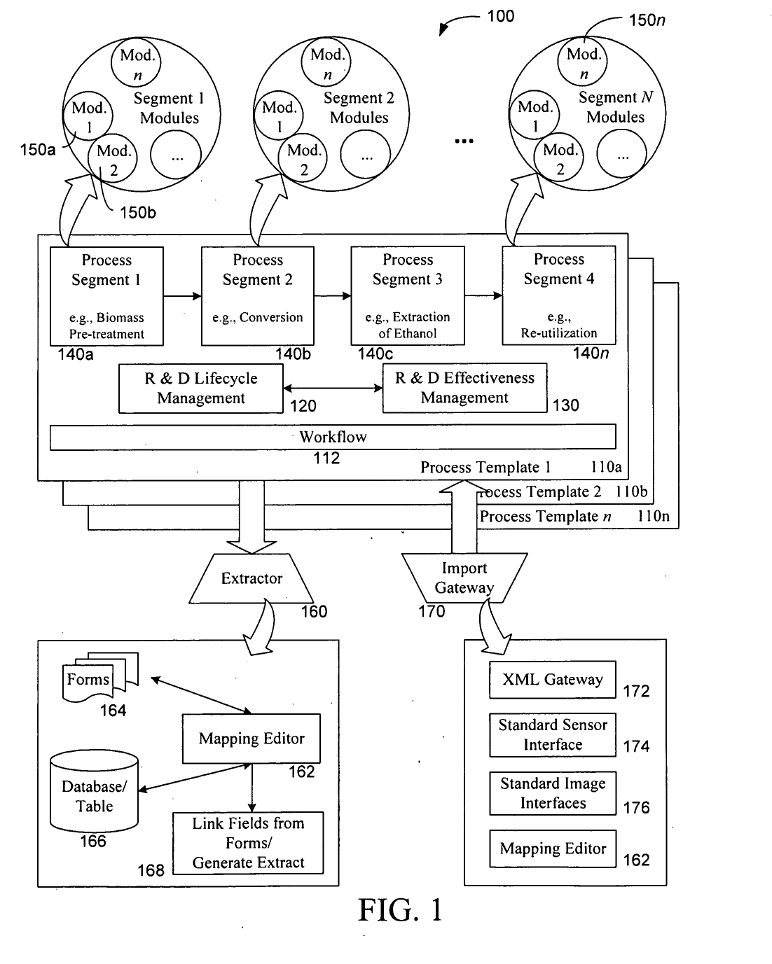

Turning now to the drawings, FIG. 1 is a high level overview of exemplary aspects of a system 100 for management of bio-fuel production research and development (R&D). The system 100 provides a configurable computer application for bio refinery application, and manages the research and development (R&D) lifecycle and maps pilot level manufacturing methods into production scale technologies. Metrics are also generated for comparison of these processes, to contribute to the emergence of an industry standard.

The system 100 includes process templates 110 that are mapped into process segments 140. The process template layer specifies configuration of a bio-fuel manufacturing or refinery process via the process segments 140. Each process segment 140 contains a group of segment modules 150 that collectively specify a stage of the refinery process. Exemplary process segments 120 and segment modules 150 are discussed in further detail below.

Data is collected at each segment module 150 and includes input data, output data and environmental data. The data is collected from other systems, environmental sensors or other input devices.

A research and development production (effectiveness) management module 130 provides for collection of the data and also for tracking the improvement in the production process. In particular, cost and efficiency are analyzed for respective combinations of input biomass, reagent and process steps within a particular manufacturing process, and improvements are expected as the process becomes more mature and is fine tuned over time.

A research and development lifecycle management module 120 provides for capturing the R&D lifecycle and effort for transformation of a technology from concept to pilot, then from pilot to demonstration, and finally from demonstration to a production technology.

Workflow 112 is configured through each process segment 140 according to the process segment modules 150 within the particular process segment 140. Specifically, workflow 112 specifies which segment modules 150 are present in a given process segment 140, and also specifies the order that the segment modules 150 are processed.

An Application Programming and Sensor Interface (APSI) provides for receiving data from external systems and sensors and also for mapping data to an external database system from the process segments 140. The APSI has two modules, an import gateway 170 and an extractor 160.

An import gateway 170 is the interface for receiving data from external systems and sensors of the manufacturing process, and into the respective process segments. Data is typically received from XML 172, standard sensor interfaces 174 and standard image interfaces 176, via a mapping editor 162.

Similarly, an extractor 160 maps the data from the process segments 140 to an external system, such as a database system. The mapping editor 162 maps data to a database 166 according to specified forms 164 and links fields from the forms to generate the extracted data reports 168, etc.

### Production of Bio Fuels

Among green technology alternatives, a configurable computer application system, such as a bio refinery application, can manage the research and development (R&D) lifecycle and map pilot level manufacturing methods into production scale technologies. Such a system can also generate a set of metrics for comparison of these processes, and contribute to the emergence of an industry standard.

Presently, at least 6 different bio-fuel manufacturing methods are being explored. These “ballpark practical” measures, such as conversion process efficiency, throughput, and average cost of unit production of bio-fuel can be extremely helpful in determining progress along the technology evolution. Also, to improve the overall efficiency and cost effectiveness, it is desirable that a system have capability to correlate these “practical set of output measures” with the input parameters, characteristics and environmental parameters, to quantify how the output improves when one feedstock is used over another, when one production method is used over another or when a particular choice of chemical or bio reagents is made with their specific property, over another.

The present invention provides for (1) managing the R&D lifecycle while also protecting the confidentiality of information, (2) managing production methods and (3) benchmarking across processes through accurate comparison.

The management of the R&D lifecycle captures information related to the R&D lifecycle and effort. Capturing the lifecycle information provides for transforming from a concept to a pilot program, from the pilot program to a demonstration, and then from demonstration to a production technology. Additionally, lifecycle management can contribute to transitioning an R&D observation by improving a manufacturing method that is already in production, simply by inserting additional process steps.

Management of production methods provides for automation of data collection at each segment and also at various stages of the production steps. These data are received, for example, from other systems, environmental sensors or other input devices. Additionally, as a process becomes more mature or fine tuned over time, improvements related to cost and efficiency are tracked for each combination of input biomass, reagents and process steps within a particular manufacturing process.

Accurate comparison contributes to benchmarking across processes. Comparison of unit costs of production and efficiency for various competitive manufacturing methods contributes to setting an industry trend for the most suited and adoptable technology for a given context. It should also be noted that each bio-manufacturing process has its own particular advantages; however the “bio” part of the process depends on factors as varied as the climate, geography, and diversity and availability of certain types of vegetation or microorganisms, among others. The present inventions contributes to determination of an approach that is best suited for a particular geography and weather pattern.

It should also be noted that while the examples discussed within this disclosure are focused primarily on cellulosic ethanol as a bio-fuel, systems and methods for management of the research and development for other bio-fuels are well within the scope of this invention.

### Feedstock and Research

Ethanol manufacturing is well known in the art. For example, the wine industry has been using ethanol manufacturing technology for a long time; indeed, some technologies for converting raw ingredients into ethanol date as far back as the 1930s.

Sugarcane and sugar beets are conventional sugar feedstocks. Brazil produces maximum ethanol from sugarcane and uses it for the transportation purposes.

Cereal grains such as corn, wheat, barley and sorghum are some of the well known starch feedstocks. The United States uses corn as the prime feedstock for ethanol production.

However, the recent technological emphasis appears to be moving away from food ingredients and instead is focusing on using non-food materials such as grass, woodstock, agricultural residue, forest residue, etc. (often referred to scientifically as “Lignocellulosic” feedstock) as the input biomass.

One example of the emphasis toward using Lignocellulosic feedstock for commercial production of ethanol is the following excerpt released by the Bio-energy Science Center (BESC), a division of DOE led by Oak Ridge National Laboratory:
Ethanol from cellulosic biomass—the most abundant biological material on the planet—has the potential to revolutionize the fuel ethanol industry and decrease U.S. dependence on imported oil. Despite its abundance, cellulosic biomass is a complex feedstock that requires more extensive processing than corn grain, the primary feedstock for conventional fuel ethanol production in the United States. Several scientific breakthroughs are needed to make cellulosic ethanol production cost-efficient enough to operate at a commercial scale.

Some typical processing steps of a future large-scale, cellulosic ethanol production facility include (1) collecting cellulosic biomass from trees, grasses, or agricultural waste, and delivering the collection to the bio refinery, (2) grinding the biomass into small, uniform particles where thermal or chemical pretreatment separates cellulose—a tough polymer of tightly bound sugar chains—from other biomass materials and opens up the cellulose surface to enzymatic reactions, (3) adding a mix of enzymes to break down the cellulose into simple sugars, (4) microbes produce ethanol by fermenting sugars from cellulose and other biomass carbohydrates and (5) separating ethanol from water and other components of the fermentation broth and purifying it through distillation. The above steps illustrate how the conversion takes place through stages.

To reduce costs, continued progress is needed in the development of energy crops dedicated to bio-fuel production, biomass-collection technologies, pretreatment methods that minimize the release of inhibitory by-products, and more efficient enzymes and microbes robust enough to withstand the stresses of industrial processing.

### Cellulosic Ethanol: Biological & Gasification

Lignocellulosic feedstocks include cellulose, hemicellulose and lignin components. Technologies for conversion of these feedstocks into ethanol are typically performed on two platforms: (1) the sugar platform and (2) the synthesis gas (or syngas) platform.

Under the sugar platform, cellulose and hemicellulose are converted to fermentable sugars, which are fermented to produce ethanol. The fermentable sugars typically include glucose, xylose, arabinose, galactose and mannose. Hydrolysis of cellulose and hemicellulose to generate these sugars is typically carried out using acids or enzymes. Pretreatments of the biomass are necessary prior to hydrolysis.

The primary objectives of the pretreatment process are to speed up the rates of hydrolysis and to increase the yields of fermentable sugars. In pretreatment processes, these goals are accomplished by modifying the structure of the polymer matrix in the biomass, thus making the carbohydrate fractions more susceptible to acid attack or more accessible to enzyme action. Lignin is normally considered a waste and is typically burned to supply thermal energy.

In the syngas platform, the biomass is taken through a gasification process, during which the biomass is heated with no oxygen or only about one-third the oxygen normally required for complete combustion. The biomass is subsequently converted to a gaseous product, containing mostly carbon monoxide and hydrogen. The gas, called synthesis gas or syngas, can then be fermented by specific microorganisms or converted catalytically to ethanol. In the sugar platform, only the carbohydrate fractions are utilized for ethanol production, whereas in the syngas platform, all three components of the biomass are converted to ethanol feedstock.

It is readily apparent that a typical gasification process template differs from a typical biological process template in mapping the conversion and ethanol recovery segments.

### Uniqueness in Bio Fuel Processing

Continuous technological improvements have occurred so that the bio fuel processing concept is becoming reality. However, these same occurrences make for a dynamic subject matter and lends itself to a system oriented study. Further, it should be noted that bio fuel processing has several variations that are not required in chemical or metallurgical processing, and pose inherent challenges. Some of the main differences between bio fuel processing and other chemical or metallurgical processing include:
1) Bio-fuel manufacturing engages micro-organisms. These living reagents are unlike chemical reagents and can be very dependent on the environment.
2) Bio-reagent can change in concentration spontaneously. For example, the number of bacteria, yeast or algae in a reactor can grow very rapidly if the environment is congenial. Again if the growth is too much, the environment may end up having too much CO₂ which in turn kills the microbes and reduce the number. Hence, internal control mechanisms are built-in to the present inventions.
3) Many parameters such as, temperature, humidity, O₂/CO₂ content can influence the living condition of the microbes, therefore controlling the environment is critical. The purpose of the present invention is not to control the reactor environment (which is performed by control systems), but rather, it is important to record the environmental parameters to know which parameters and input characteristics produce a steady high ethanol conversion rate (“ECR”). For this, an easy way to upload data from various sensors at a pre-set frequency is provided. The data type can be data or image.
4) The bio-refinery processes are still very R&D intensive and can be subject to various trials. The present invention supports organizing the R&D effort so that a manufacturing process can be launched in a more managed fashion. The invention also provides an indication of the progress in R&D around important milestones.
5) In addition, the invention has the flexibility to accommodate introduction, modifications or removal of processing steps, or making changes around reagents, environmental variables or input materials without the need for system modifications.
6) Unlike typical enterprise applications (such as SAP, Oracle Applications), bio-refinery application benefit from being very friendly to various sensor interfaces. In fact, the APSI provides the center of functionality of bio-refinery application management.

### Architecture Paradigm

Returning again to FIG. 1, the architecture for management of bio fuel refinery research and development is discussed in further detail. Process template layers 110 accommodate the configuration of diverse manufacturing methods within the system 100. Additional templates are added individually as the product becomes more mature. Exemplary process template layers 110 include (1) cellulosic ethanol biological template, (2) cellulosic ethanol gasification template, (3) algal biodiesel template, (4) green gasoline template, (5) biobutanol template, (6) designer hydrocarbons template and (7) fourth generation fuel template.

It should be noted that process template layers 110 can differ from each other significantly. For example, a gasification template layer uses process steps such as gasification and pyrolysis, whereas the biological template uses hydrolysis and fermentation type processes.

The system 100 framework includes three basic components to facilitate the flexibility for the various process template layers 110: (1) process segments 140, (2) an APSI (extractor 160, import gateway 170), and (3) a configurable workflow engine 112.

A process template layer 110 typically includes four standard process segments 140 for (1) feedstock pretreatment, (2) conversion, (3) extraction of ethanol or ethanol recovery, and (4) re-utilization. A typical process template layers 110 is mapped into these four main segments to describe the functionality of the process flow. Each process segment 140 includes handshake capability with other process segments 140 based on the fundamental guide to the workflow as prescribed in the process template layer 110.

Processes mapped into each process segment 140 include segment modules 150 that include the functionality of process steps. In one exemplary embodiment, a cellulosic ethanol biological manufacturing process template layer includes segment modules such as (1) a biomass handling module, (2) a biomass pretreatment module, (3) a hydrolysis module, (4) a fermentation module, (5) a fuel recovery module, and (f) a lignin utilization module. However, an algal bio-fuel or bio-butanol process, can include different segment modules 150 as driven by the process template layer 110.

Additionally, segment modules 150 can be added to a respective process segment to adjust for measured results, and also to adjust the workflow between respective segment modules.

The manufacturing methods are mapped into the process template layers 110. It should be noted that there is presently no industry standard for this mapping, and proprietary methods for such mapping are likely to be developed. Each process template layer 110 is placed into a setup repository along with details for the schema and application objects.

Each segment module 150 typically records processing time, volume, weight and flow, where appropriate for the input and output materials. Additionally, data related to the chemical or bio-reagents, such as concentration, are also captured.

Information is typically transferred from one process segment 140 to another based on triggering events as the raw materials convert to fuel. The configurable workflow engine 112 guides the internal flow of information.

The import gateway 170 includes a dedicated application interface for transferring data from various sensors or other machines at a pre-set frequency, for example. Additionally, images can be automatically uploaded, whether the images are optical or various types of microscopy.

Segment modules 150 are typically self sufficient in calculation of a running cost estimate for the process steps within that module. The total bio fuel production cost is an aggregate of the segment module 150 costs.

Typically, an implementation specifies the configuration of a bio fuel manufacturing process. Typical implementations specify (1) manufacturing methods and (20 application programming and sensor interfaces. The manufacturing methods drive the process template layer 110 (mapping to four process segments 140), which drives the process modules 150, which drive the process steps (within segment modules), which drives the workflow between steps via the workflow engine 112. The application programming and sensor interfaces drive configuration of APSI tables for each interface, and dictates (1) the format of data transfer, (2) type of data, e.g., machine data, expressions, image, files, (3) frequency of data capture and (4) source of data.

The R&D Lifecycle management module 120 provides for maintaining confidentiality for technical secrets, and promoting R&D concepts from the pilot program to a demonstration, and then from demonstration to a production technology.

Segment modules 150 provide the capability for adding new process steps within an existing manufacturing method. One exemplary embodiment uses a configurable drag and drop workflow engine to alter or add process steps and/or segment modules 150. For example, improvements related to deconstruction microbes and deconstruction enzymes is likely to be a regular research thrust for the foreseeable future. Adding or modifying process steps within the manufacturing method without undue technical expertise is readily available within the present invention.

Additional process template layers 110 can be configured and can collocate with any existing process template layer 110. For example, an algal bio-fuel template can be a new process added to an existing cellulosic ethanol process.

The system 100 includes the standard components of an enterprise level business application such as, (1) an application layer, (2) workflow and object foundations, (3) communication layer, (4) middleware and (5) database layer. Each layer provides for the customary features for that particular layer, such as security, for example.

### System Description

The basic processes for converting sugar and starch crops to ethanol are well-known and are presently in use commercially. While these type plants generally have greater value as food sources than as fuel sources, some exceptions exist. For example, Brazil uses huge crops of sugar cane to produce fuel for its transportation needs. The current U.S. fuel ethanol industry is based primarily on the starch in the kernels of feed corn, America's largest agricultural crop.

### Cellulosic Ethanol Biological Process Template

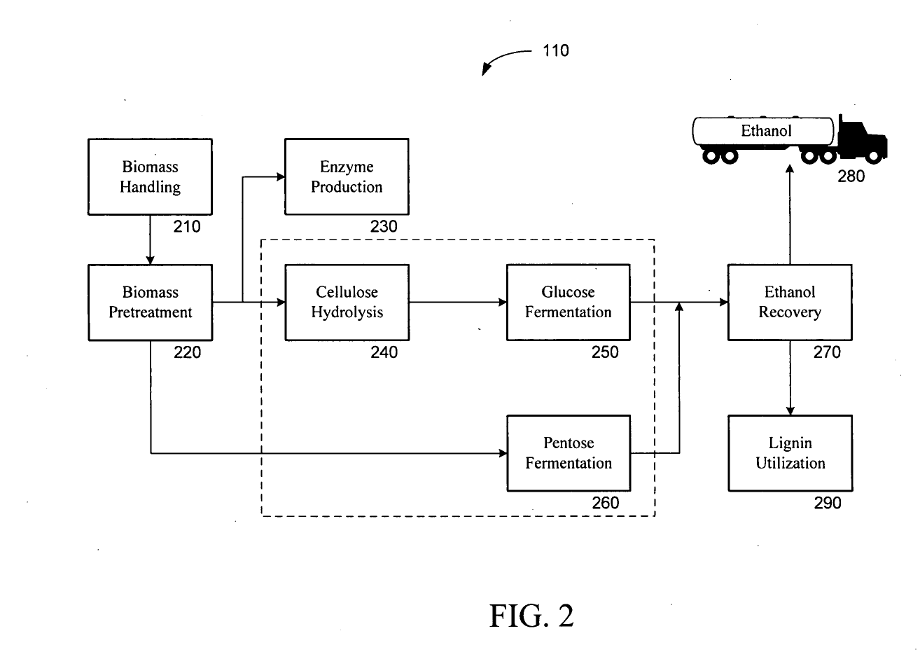

FIG. 2 is a diagram illustrating an exemplary process template 110 for the manufacture of cellulosic ethanol from biomass using a biological conversion template. In particular, bio fuel refinery is illustrated via a cellulosic ethanol biological process template. The accepted steps are shown for manufacture of cellulosic ethanol from biomass using a biological conversion template. The manufacturing process is broken into the four previously mentioned manufacturing process steps, or process segments: feedstock pre-treatment, conversion, ethanol recovery (extraction of ethanol) and re-utilization.

Pre-treatment. Pre-treatment in the cellulosic ethanol biological process includes biomass handling 210 and biomass pretreatment 220.

During the biomass handling 210 process segment, the biomass goes through a size-reduction process step that makes the ethanol production process more efficient. For example, agricultural residues go through a grinding process and wood goes through a chipping process to achieve a uniform particle size. In the bio-fuel application layer discussed below, configurable are provided so that the above processes, whether chipping or grinding, are mapped properly to reflect the manufacturing process.

During the biomass pretreatment 220 process segment, the complex chains of sugars that make up the hemicellulose are broken to release simple sugars. Though chemical pretreatment is prevalent, depending upon the biomass nature and manufacturing approach in use, different sub-steps including mechanical, thermal, and/or their combinations with chemical process have been experimentally used to achieve breaking these complex chains. When dilute sulfuric acid is mixed with the biomass feedstock chemically, the complex hemicellulose sugars are converted to a mix of soluble C₅ sugars, xylose and arabinose, and soluble C₆ sugars, mannose and galactose. A small portion of the cellulose is also converted to glucose in this step. However, depending upon the raw material used as biomass other pretreatments may become necessary, such as (1) dilute sulfuric acid pretreatment, (2) steam explosion, (3) amonin pretreatment, (4) lime pretreatment, (5) alkaline peroxide pretreatment, (6) wet oxidation, (7) organic solvents and (8) ionic liquid fractionation.

Conversion. Conversion in the cellulosic ethanol biological process includes hydrolysis, fermentation, enzyme production 230, cellulose hydrolysis 240, glucose fermentation 250 and pentose fermentation 260.

Hydrolysis is the chemical reaction that converts the complex polysaccharides in the raw feedstock to simple sugars. In the biomass-to-bioethanol process, acids and enzymes are used to catalyze this reaction.

Fermentation is a series of chemical reactions that convert sugars to ethanol. The fermentation reaction is caused by yeast or bacteria, which feed on the sugars. Ethanol and carbon dioxide are produced as the sugar is consumed.

In the enzyme production 230 step, the cellulase enzymes that are used to hydrolyze the cellulose fraction of the biomass are grown. Alternatively the enzymes might be purchased from commercial enzyme companies.

In the cellulose hydrolysis 240 step, the remaining cellulose is hydrolyzed to glucose. In this enzymatic hydrolysis reaction, cellulase enzymes are used to break the chains of sugars that make up the cellulose, releasing glucose. Cellulose hydrolysis is also called cellulose saccharification because it produces sugars.

During the glucose fermentation 250 step, the glucose is converted to ethanol, through fermentation. Fermentation is a series of chemical reactions that convert sugars to ethanol. The fermentation reaction is caused by yeast or bacteria, which feed on the sugars. As the sugars are consumed, ethanol and carbon dioxide are produced.

The hemicellulose fraction of biomass is rich in five-carbon sugars, which are also called pentoses. Xylose is the most prevalent pentose released by the hemicellulose hydrolysis reaction. In the pentose fermentation 260 step, xylose is fermented using Zymomonas mobilis or other genetically engineered bacteria.

Ethanol Recovery. The fermentation product from the glucose and pentose fermentation is called ethanol broth. During the ethanol recovery 270 step, in the cellulosic ethanol biological process, the ethanol 280 is separated from the other components in the broth. A final dehydration step removes any remaining water from the ethanol 280.

Re-utilization. Re-utilization in the cellulosic ethanol biological process includes lignin utilization 290 and chemical and reagent recycling.

During lignin utilization, lignin and other byproducts of the biomass-to-ethanol process can be used to produce the electricity required for the ethanol production process. Burning lignin actually creates more energy than needed and selling electricity may help the process economics.

In order to recycle the same reagents such as sulfuric acids, ammonia, etc., the used reagents are purified. Chemical and reagent recycling is a dedicated application module to manage the processes for purifying the used reagents.

### Application Modules

In one exemplary embodiment, a process template (Cellulosic Ethanol) is mapped to the application modules for production and manufacturing. Typically, core modules and auxiliary modules are designed to cover two fundamental business requirements of biomass to cellulosic ethanol production (“B2CE production”) and R&D to manufacturing (“R&D2 manufacturing”).

B2CE production processes are typically used for manufacturing bio-fuel. The input, output and environmental data are recorded so that the best combinations can be achieved much quickly and with little guesswork in the process.

R&D to manufacturing manages the lifecycle of a bio-fuel R&D process until the process is mature enough to become a production technology. As the manufacturing technology matures from concept to pilot, then from pilot to demonstration, and finally from demonstration to production, R&D2 manufacturing coordinates various activities necessary to make transformation efficient and smooth. Further, each of these stages can be managed while keeping any proprietary information confidential.

### Core Modules: B2CE Production

Biomass handling module. The biomass handling module provides the capability to capture data around various size-reduction steps taken during the cellulosic ethanol manufacturing process. These steps can be (1) chipping and (2) grinding.

The biomass handling module configures the application to capture and utilize the data around input, output and processes in this step. The data input can occur directly through the input forms of the applications, uploading files through the application interface, or interfacing with other input devices such as weighing machine, or bar code scanner, for example. The module supports these possible interface types. The biomass handling module typically has, among other capabilities, screens that allow a user to input, update, de-activate (delete where permitted) information on the following items:
1. Feedstock or Raw material: Attributes such as category, type and nature of raw material, the volume, weight of the raw material. Information providing where the Feedstock was obtained can also be captured.
2. Machines: Attributes such as the type and category of machine used. The machine capacities, machine maintenance schedules and various status indicators of the machine.
3. Operational Metrics: The operational data can be automatically updated from the sensors of the machines, for example, to capture the actual speed, running time of the grinds or chipping machines, outflow of the output and also the average particle (mesh) size.
4. Formula: Formula can be used for calculation such as cost of operation and efficiency.
5. Application Interface: Data can be uploaded from electronic (sensor) data sources, both real time and using a batch process.
6. Other Info: This section is kept to preserve scalability and to accommodate any possible future process requirement that the bio-fuel application may accommodate.

Biomass pretreatment module. The biomass pretreatment module provides capability to capture the data related to combinations of mechanical, thermal processing and chemical processing, such as treatment with acids and alkalis. Not all steps in this module are mandatory; the feedstock nature and quality dictates the choice of steps required in this process. Thus the module is setup appropriately for a particular manufacturing approach (or in a particular manufacturing plant).

The biomass pretreatment module is configured with elements, such as equipment and operational parameters to quantify the main outputs with reasonable accuracy:

1. Thermal Processing:
a. Boiler vessel or other equipments: The boiler is configured appropriately so that capacity, volume, temperatures, etc., can be captured.
b. Operational metrics: The application has capability to capture the data directly from the sensors or similar devices with a prior sampling interval, to maximize the efficiency of each sub process.

2. Mechanical Processing:
a. Tumbler/rotator or other equipment: Captures the details of the rotator.
b. Operational metrics: Interface with automated data collection mechanism to ensure that the process is running optimally.

3. Chemical Processing:
a. Chemical environment:
   i. Reactors: Capture the details of the reactor.
   ii. Reagents: The application is configured to capture details such as volume concentration around reagents used, such as sulfuric acids etc.
b. Operational Metrics: Interface with the flow meters/weighing machines to capture the rate of chemicals flowing in and out of the reaction vessels.

Hydrolysis module. The hydrolysis module provides the capability to measure the environment and the results from the chemical reactions that convert polysaccarides of the feedstock into the glucose.

The hydrolysis module is configured to assess the hydrolysis process output, efficiency and thereby cost.
1. Inputs:
   a. Water: For an economically viable process, the solids content feeding the hydrolysis step should be as high as possible, typically 20 percent to 30 percent or more. Excess water not only dilutes the enzymes added for hydrolysis, reducing the reaction rate, but also dilutes the sugars produced. Therefore control on water percentage is very critical. This module contributes to automation of management of water concentration.
   b. Reagents: Charts the reagents that are required for different stages of the Hydrolysis process. Generally cellulose hydrolysis is a second step that takes the remaining cellulose into glucose.
2. Batch Reactor: This is often required for the stirring and agitating the formed slurry. This feature of the bio fuel application is configured to capture the necessary data regarding setting, running and maintenance of the batch reactors.
3. Separation & Filtration: The separation and filtration feature ensures that the filtration process is yielding the desired efficiency and is producing the quality required for the fermentation process.

Fermentation module. The fermentation module is unique to the bio technology process. The reagents are microorganisms that influence the fermentation.

The fermentation module captures and improves the fermentation rate. To quantify the process better, this module is configured so that critical measures can be collected at a sampling frequency in the application database. This information can then provide insight regarding the factors contributing to the rate improvement:
1. Fermentation Environment: Important parameters are typically the temperature, humidity, enzyme and yeast concentration, etc. The fermentation environment step collects data that should interface from sensors housed in the reactor. In addition, the quantification of bio-reagents requires defining proper bio metrics and a basis of comparison.
2. Pentose Fermentation: The pentose fermentation step requires cultured bacteria that can process Xylose into Glucose. Data is collected that relates to the fermentation rate. In some instances, new metrics are defined first in order to derive this rate information.
3. Glucose Fermentation: Glucose fermentation is primarily carried out by yeast, though some bacteria can also help accelerate the process. Data is collected that relates to the fermentation rate. In some instances, new metrics are defined first in order to derive this rate information.
4. Operational Metrics: This application feature captures critical measurable output details such as, the amount of time spent in the fermentation chamber.

Ethanol recovery module. The ethanol recovery module is the last step before ethanol is filtered out of the ethanol broth.

The ethanol recovery module is configured to obtain information regarding the recovery process and to deduce the rate of ethanol recovery. If quantified data can be found, then the efficiency can be increased through changing the controllable variables. Some of the key focus areas for the ethanol recovery module are (1) defining process input/output, (2) filtration and separation, and (3) dehydration.

Reutilization and waste management module. By-products such as generation of electricity from burning Lignin are features that can be mapped in this auxiliary module.

### Foundation Modules

The bio fuel application can coexist with any existing enterprise applications such as SAP or Oracle Applications Suite, etc. These suites naturally contain the supply chain, purchasing, HRMS and finance modules to run the complete business. The bio fuel application does not include the above mentioned features. However, as mentioned above, some critical auxiliary modules are included, such as (1) the workflow engine, (2) the process template manager and (3) the APSI module.

Workflow engine. The workflow engine ensures that a system process is performed in a proper sequence and provides alerts in case of errors.

Process template manager. The process template manager ensures that as each manufacturing process is installed, it is installed with correct forms, reports, access to modules and proper workflow behind.

APSI module. The APSI—application programming and sensor interface—module is configured to build various interfaces through which machine/sensor sampled data can be automatically interfaced into the application. This API is used for both research and production. Some seeded interfaces include (1) image, (2) sensor data and (3) files/XML information, each of which are as follows:
a) Image: Images such as photography images, microscopy images or specialized high resolution images (such as SEM/AFM etc.) can be uploaded into the database through this interface. An XML Gateway based interface can be used to achieve image transfer from a camera or other optical image sources into an Oracle Database.
b) Sensor Data: Sampled data from the machine or sensors at a pre-set frequency are automatically uploaded into the database. The application uses middleware such as Oracle Sensor Edge Server for interfacing with the sensors.
c) Files/XML information: Other computer systems can transfer files in batch or real time basis to the bio-fuel database. A gateway such as an XML Gateway is used to ensure real time file/data transfer from another system.

Data capture from various machines and sensors, for example, helps to quickly to analyze and correlate factors that influence the environment and thus impact the throughput of the process. This type study converges to the choice of the best input and controllable environmental parameters to increase the yield and efficiency of ethanol conversion.

### Core Modules: R&D2 Manufacturing

Those involved in producing alternate bio-fuel presently are doing research into finding higher quality microorganisms (such as bacteria, yeast, algae, etc.) that converts biomass into fuel at a higher conversion rate. These modules are important to manage the intensive R&D methods in the bio-fuel industry today.

Bioreagent and enzyme optimization module. The flexible bioreagent and enzyme optimization module allows mapping of the critical features of the environment and specimens of microorganisms used. Salient mapping is used with respect to the following items; however, the applications are scalable enough to focus on other areas as they become important for the R&D study.

The bioreagent and enzyme optimization module primarily assists the R&D effort regarding culturing microorganisms in-house.

Grow microbe. The grow microbe module is for capturing data related to characterizing the microbe, identification of the enzyme and quantification of growth rate based on the environmental parameters, such as microbial organisms, enzyme technology, screening technology, optimizing culture platform and environment, gene evolution technology and throughput analysis.

As an example, the grow microbe module has the flexibility to configure the application so that data required to improve the effectiveness of the bio-reagents can be automatically-interfaced, stored and analyzed. Some of the R&D steps presently being used are DNA isolation, fractionation, normalization and library screening.

Acquire microbe. Some manufacturing plants are not in the business of performing R&D around enzymes. If the required enzyme for producing bio-fuel is purchased, then this feature is used. In this event the amount, concentration, and cost are some of the basic information to store.

R&D lifecycle management. R&D lifecycle management contributes to staging an R&D effort through (1) proof of concept, (2) pilot, (3) demonstration and (4) moving to production. At each stage, data is collected to measure the time elapsed, the result obtained and an indication of effort and cost.

### Technical Approach

The technical approach section discusses the architectural designs, the major components of the framework and the APSI layer along with the capability of the mapping editor in pointing to source or destination fields in the schema.

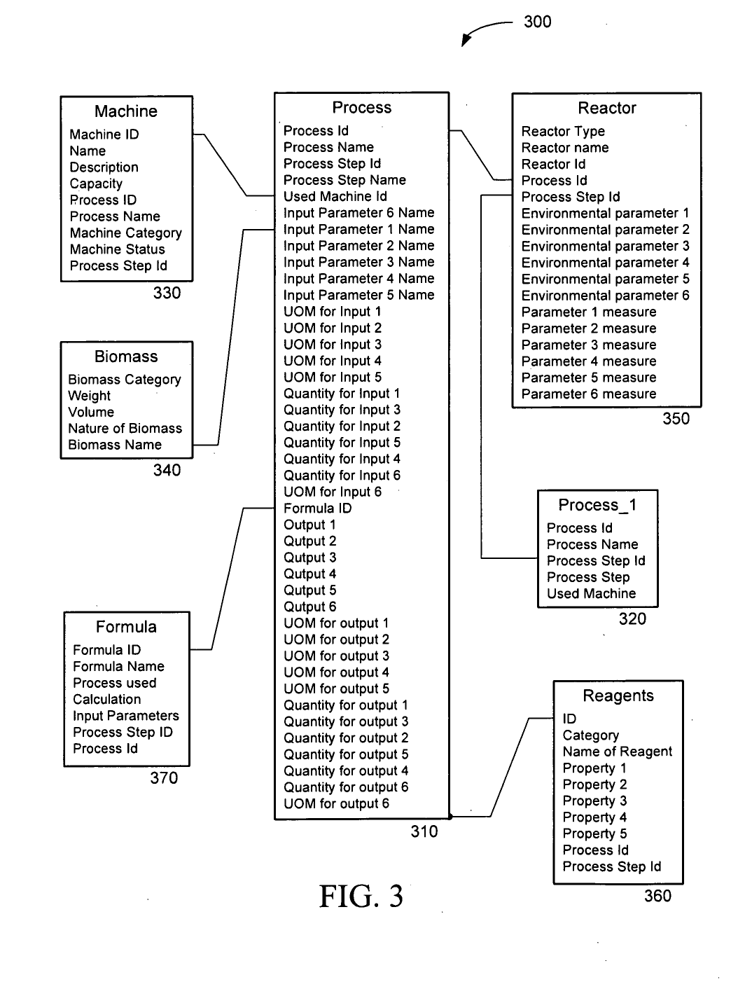

FIG. 3 is an exemplary entity relationship diagram (ERD) 300 for a database illustrating the relationship of a process template layer 110 as linked to a process 310, and with the process 310 linked to process elements such as reagent 360 and reactor 350. Reagent 360 includes names and properties of the reagents used in the process 310, for example. Reactor 350 includes environmental parameters and measurements, among others, and has a process step ID of process_{—}1 320, for example. Other elements of the process 310 include machine 330, biomass 340 and formula 370. It should be noted that the core schema presents the general idea rather than an illustration of a complete ERD. It should be further noted that the ERD is scalable and more tables can be added as the application requires them.

It should be noted that the product suite can be built on any technology platform (e.g., Windows, Linux, Unix), using any middleware and using any development tools (e.g., Java, .NET, Oracle Developer Suite) and any database (e.g., mysql, Oracle). Also any communication mechanism (e.g., SOAP, XML) can be used in the bio-fuel application.

In one exemplary development environment, Oracle is used as the database, Oracle Application Server is the middleware while Service Oriented Architecture and XML provide the communication platform. Oracle Developer Suite can be the development tool.

It will be readily appreciated by those of skill in the art that a database can interface different data types, such as expression, pathways, machines, and imaging, for example.

In one embodiment, the present invention targets an implementation of image, machines (or sensors), and expressions such as data. This capability is provided in an import gateway 170 provided by an APSI layer.

The APSI layer is universal and as each interface is defined by a mapping editor 162, each interface incoming or outgoing is saved in the database 166 and is run according to schedule. The mapping editor 162 helps to identify source and destination placeholders by browsing the application forms 164. If a field does not exist, the mapping editor 162 provides the capability for the user to create and identify the placeholder appropriately before using it in the interface design.

### Foundation Architecture

It should be noted that with the advents over the previous two decades in database and business application technology, the fundamentals have not changed significantly. The primary components of any business application from the user standpoints (omitting middleware, network connectivity, and security related infrastructure technology layer) are still the database, the forms, data presentation (reports or dashboards) and the interface (peripherals).

The database houses the information. Forms provide search capability into the data stored in the database while also serving as the entry portal of the data. Reports or dashboards provide data presentation, the capability to extract data. Interfaces are the gateway to the data that originates from other systems or devices. Such data can be stored in the application database real time or in batch depending on the processing mode of the interface.

IT applications function adequately under this approach, however, bio applications are different in concept. Bio applications deal with living organisms which can grow and die. Thus, the environment is more dynamic than conventional applications. Also, bio applications are R&D intensive and therefore bio-refinery applications require a lot more built in flexibilities in order to account for the changing environment.

The present invention differs from conventional monolith business applications in concept. Monolithic applications, e.g., Oracle Apps, SAP, are rigid. The core applications dictate how the interfaces exchange data with the CORE applications. The present invention allows for the dominance of the interfacing systems or devices. It is alterable to entertain new information from a new device or even from other systems. In the present invention CORE functionalities can depend on the data that is received from the external system.

In one exemplary embodiment, a fermentation reactor, there are three sensors for temperature, humidity and auto-imaging of the ethanol broth every 15 minutes. At some point it becomes desirable to add a new sensor for spot checking the average concentration of microbes in ten places within the reactor once per hour. It is desired to feed this data as a measure of process progress.

Monolithic business applications have no built in flexibility to easily accommodate the addition of new sensors to the bio application. The present invention allows for this process change around the interface.

This high level concept is shown FIG. 1 through multiple process template layers 110. Interface modifications are discussed further below. Each process template layer 110 along with the seeded workflow becomes an implementation unit. Each process template layer 110 can coexist with other process template layers 110 and each process template layer 110 and its components (such as process segments 140 or segment modules 150 inside each segment) are completely configurable and alterable.

### APSI Layer

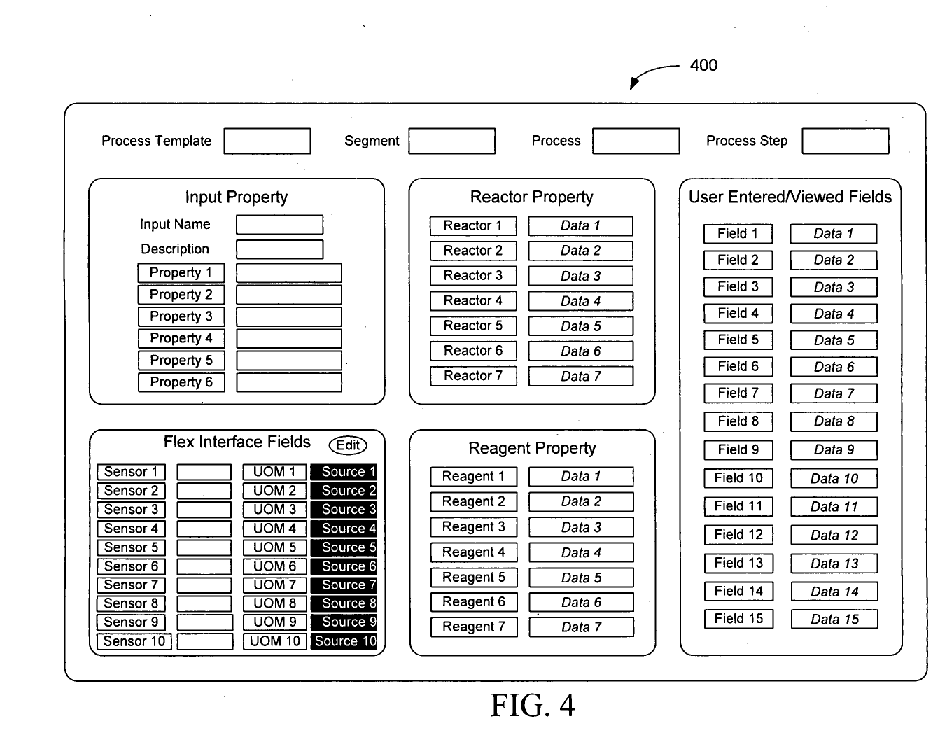

FIG. 4 is an exemplary form for prescribing the elements in a bio application form for mapping data to the process segments 140 from other systems or external sensors, as well as to the database 166 from the process segments 140. The Application Programming and Sensor Interface (APSI) layer of the architecture has two modules: the extractor 160 and the import gateway 170.

The extractor 160 sends data from the bio-refinery applications to external systems and operates as a mapping tool to provide this data export capability. The mapping tool is user friendly and is for use by non-IT bio-refinery experts. The mapping editor 162 provides capability for a user to point and choose each form or field from the location where the data is collected. The format for data dumping (XML, flat file, etc.) is also selectable. Thus, the internal logic operates to create the exported data according to user preference.

The entire database is tagged by segment. For example, if the user selects:
Segment>Module>Form>Field
   and then provides a name, and then provides a position or sequence of the variable in the dump file, e.g. XML or flat file, the logic automatically creates a program for generating the extracted file.

The import gateway 170 provides for importing data from other systems or from external sensors. Several categories of data that require import from sensors or systems include (1) sensor data, (2) XML data (real time), (3) XML or flat file (batch processing) and (4) images.

Each type interface has a configurable template and these templates replicated and edited to suit the specific need. Using the mapping editor 162, non-IT business users point to a form where the data is to be stored. If no placeholder exists in the form for this new variable from the new interface, the user is able to request a new placeholder be added to the form.

Data is imported to the bio-refinery application and read from the format presented, e.g. XML, flat file, machine/sensor level data exchange and the like. Once the data is read, it is transferred according to the APSI tables specified for that process segment 140. APSI tables have the redundancy to accommodate new information also. The tables and columns are identified for storage of the data in accordance with the destination field identified by the mapping editor 162. Additionally, the mapping editor 162 provides capability for the user to enable a new field in the form. The placeholder for enabling new fields is visible along with the data field.

It should also be noted that the images, e.g. data type image, are stored in separate table or databases with proper linking IDs. Thus, when the form is open, image based data is retrievable in accordance with user specified requirements. Of course, thumbnail footprints presentation capability is also available.

Each form typically has three categories of fields (1) user modifiable blocks, (2) hybrid blocks and (3) flex blocks. Referring again to FIG. 4, the ‘User Entered/Viewed’ block is illustrative of fields that the user can modify by entering data, querying for data and viewing the data.

A hybrid block includes portions that can be modified by the user but also has portions that the user cannot modify. Examples of non-modifiable portions of hybrid blocks are the ‘Input Property’ field, the ‘Reactor Property’ field and the ‘Reagent Property’ field. If mapped with the flex interface fields using the mapping editor 162, these fields automatically are non-enterable and non-updateable.

A flex interface fields block allows for mapping the fields using the mapping editor 162. Once these fields are mapped (via the edit functionality), the data is supplied from a sensor or other machine and cannot be otherwise updated.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A computer-implemented method for management of bio-fuel production research and development, the method comprising:
mapping at least one process template layer into a plurality of process segments, wherein each process template layer specifies configuration of a bio-fuel manufacturing process via the plurality of process segments, and wherein each process segment specifies a stage of the bio-fuel manufacturing process via a grouping of segment modules;
recording specified data at each segment module, wherein the specified data includes input data, output data, and environment data;
configuring workflow through each process segment according to the segment modules within the respective process segment, and wherein the workflow specifies the segment modules that are present and the order of the segment modules; and
providing the specified data to a research and development lifecycle management module for determination of results based on tracking and comparison of specified data, and wherein segment modules are modified based on the determined results.

2. The computer-implemented method of claim 1, further comprising adding at least one segment module to a respective process segment based on the determined results.

3. The computer-implemented method of claim 1, wherein each segment module includes a plurality of process steps that define the workflow between the respective segment modules.

4. The computer-implemented method of claim 1, wherein the process template layer includes at least one of the following:
cellulosic ethanol biological template;
cellulosic ethanol gasification template;
algal biodiesel template;
green gasoline template;
biobutanol template;
designer hydrocarbons template; and
fourth generation fuel template.

5. The computer-implemented method of claim 1, wherein each process segment specifies one of the following:
pre-treatment of biomass to separate cellulose from other biomass materials;
conversion of cellulose into simple sugars;
extraction of ethanol from water and other components of the simple sugars; and
re-utilization of by-products to produce electricity for ethanol production and to purify used reagents from the conversion.

6. The computer-implemented method of claim 4, wherein the cellulosic ethanol biological template includes the following segment modules:
biomass handling module;
biomass pretreatment module;
hydrolysis module;
fermentation module;
fuel recovery module; and
lignin utilization.

7. The computer-implemented method of claim 1, wherein the specified data further includes at least one of the following:
chemical reagent data; and
bio-reagent data.

8. The computer-implemented method of claim 1, wherein recording the specified data further comprises recording process functionality information.

9. The computer-implemented method of claim 1, wherein the environment data includes interface data.

10. The computer-implemented method of claim 9, wherein the interface data includes sensor data.

11. The computer-implemented method of claim 1, wherein the workflow further comprises transferring information from one segment module to another segment module based on triggering of events.

12. The computer-implemented method of claim 1, wherein the recording further utilizes an application programming and sensor interface (APSI) that specifies the following:
format of data transfer;
type of data;
frequency of data capture; and
source of data.

13. The computer-implemented method of claim 12, wherein the recording further comprises receiving an automatic upload of an image data type.

14. The computer-implemented method of claim 1, further comprising maintaining confidentiality of the specified data.

15. A system for management of bio-fuel production research and development, the system comprising:
a plurality of computer-implemented process template layer modules, wherein each process template layer module specifies configuration of a bio-fuel manufacturing process and further comprising:
a plurality of process segments, each corresponding to a particular stage of the bio-fuel manufacturing process;
a research and development production management module configured to record specified data at each process segment, wherein the specified data includes input data, output data, and environment data; and
a research and development lifecycle management module configured for determination of results based on tracking and comparison of the specified data and to modify process segments to achieve desired results in the bio-fuel manufacturing process; and
an application programming and sensor interface (APSI) for importing and extracting data, the APSI comprising:
an import gateway configured to import the specified data to each process segment, and wherein the specified data is imported from at least one of the following:
external systems; and
external sensors; and
an extractor configured to map data from each process segment to an external data system.

16. The system of claim 15, wherein the extractor further comprises a mapping editor configured for user selection of a form having the following fields that specify a data storage location:
static data;
environmental data; and
configurable data.

17. The system of claim 16, wherein the mapping editor is further configured for user specification of a new data storage location in the absence of a configurable data field in the form.

18. The system of claim 15, wherein the APSI further comprises:
an XML gateway;
at least one standard sensor interface;
at least one standard image interface; and
a mapping editor.

19. The system of claim 15, wherein the APSI further comprises a logic module for addition of at least one external sensor.
